(19) United States
(12) Patent Application Publication
(10) Pub. No.: US 2011/0153902 A1
(43) Pub. Date: Jun. 23, 2011

(54) Test Interface Card and Testing Method

(75) Inventors: Chiao-Lun Tsai, Taipei (TW); Kuo-Hong Chuang, Taipei (TW)

(73) Assignee: Wistron Corporation, Taipei (TW)

(21) Appl. No.: 12/883,657

(22) Filed: Sep. 16, 2010

(30) Foreign Application Priority Data
Dec. 18, 2009 (TW) 098143653

(51) Int. Cl. G06F 13/20

(52) U.S. Cl. 710/313

(57) ABSTRACT

A test interface card includes: a first specification bus adapted for coupling between a first specification interface controller of a device under test (DUT) and a signal converting interface card, and for transmitting a first test signal that is outputted by the first specification interface controller to the signal converting interface card for processing; a second specification bus adapted for coupling between the signal converting interface card and a storage module of the DUT, and for transmitting a processed signal that is outputted by the signal converting interface card as a result of processing the first test signal to the storage module; and a third specification bus adapted for forming a closed circuit with a second specification interface controller of the DUT, and for transmitting a second test signal that is outputted by the second specification interface controller back to the second specification interface controller.

### CROSS-REFERENCE TO RELATED APPLICATION

This application claims priority of Taiwanese application no. 098143653, filed on Dec. 18, 2009.

### BACKGROUND OF THE INVENTION

1. Field of the Invention

This invention relates to a test interface card, more particularly to a test interface card adapted to be coupled to a blade server for facilitating testing of the blade server.

2. Description of the Related Art

A blade server 900 is a device in which a processor, memory, hard disk, and other hardware of a server system of the blade server 900 are all integrated on a single motherboard or ‘blade’. Such configuration allows a plurality of such servers to be housed and operated simultaneously in a blade enclosure, in which a power supplying device, display device, etc. are shared amongst the servers so as to achieve effective systems integration.

However, testing of the blade server 900 is complex due to the blade enclosure providing many different specification buses to which the blade server 900 is to be connected, such as a Peripheral Component Interconnect Express (PCI-E) bus, a Serial Attached SCSI (SAS) bus and a Serial Advanced Technology Attachment (SATA) bus.

Referring to FIG. 1, when the blade server 900 is to be tested against a PCI-E bus 910 and a SAS bus 920, it is necessary to couple the PCI-E bus 910 between the PCI-E controller 901 of the blade server 900 and a SAS interface card 902, and to couple the SAS bus 920 between the SAS interface card 902 and a storage module 903 of the blade server 900. Such test circuit configuration allows transmission of a PCI-E test signal outputted by the PCI-E controller 901 to the SAS interface card 902 through the PCI-E bus 910, and transmission of a SAS test signal outputted by the SAS interface card 902 as a result of performing specification conversion on the PCI-E test signal to the storage module 903 through the SAS bus 920. Receipt of the SAS test signal by the storage module 903 indicates that the blade server 900 has passed testing against the PCI-E bus 910 and the SAS bus 920, while failure to receive the SAS test signal by the storage module 903 indicates a broken or damaged portion of the test circuit responsible for signal transmission via at least one of the PCI-E bus 910 and the SAS bus 920 that requires inspection and repair.

In contrast, when the blade server 900 is to be tested against a SATA bus 930, it is first necessary to exchange the SAS interface card 902 for an interface card corresponding to the SATA bus 930. The SAS interface card 902 is thus exchanged for a SATA interface card 902′ that is capable of converting a SATA test signal outputted by the SATA controller 904 to a SAS test signal, as shown in FIG. 2. The SATA bus 930 is then coupled between the SATA controller 904 of the blade server 900 and the SATA interface card 902′, and the SAS bus 920 is coupled between the SATA interface card 902′ and the storage module 903 of the blade server 900. This test circuit allows testing of the blade server 900 against both the SATA and SAS buses 930,920 in a manner similar to that in which the blade server 900 is tested against the PCI-E and SAS buses 910,920: the SATA test signal outputted by the SATA controller 904 is transmitted through the SATA bus 930 to the SATA interface card 902′, and the SAS test signal outputted by the SATA interface card 902′ is transmitted to the storage module 903 through the SAS bus 920.

Since the conventional method for testing the blade server 900 described above involves exchange of the SAS interface card 902 for another interface card in order to test the blade server 900 against a different one of the specification buses, as the number of the specification buses against which the blade server 900 is to be tested increases, so does the number of times the SAS interface card 902 needs to be exchanged. Such exchanges result in increased testing time and costs. Moreover, configurations of the test circuits shown in FIGS. 1 and 2 cause repeat testing of the blade server 900 against the SAS bus 920, thus further wasting testing resources.

### SUMMARY OF THE INVENTION

One object of the present invention is to provide a test interface card that enables testing of a device under test (DUT) against many different specification buses without requisite exchange of an interface card.

According to the present invention, there is provided a test interface card adapted to be coupled between a DUT and a signal converting interface card for facilitating testing of the DUT. The DUT has a first specification interface controller, a second specification interface controller and a storage module. The test interface card comprises a first specification bus, a second specification bus and a third specification bus.

The first specification bus is adapted for coupling between the first specification interface controller and the signal converting interface card, and for transmitting a first test signal that is outputted by the first specification interface controller to the signal converting interface card for processing. The second specification bus is adapted for coupling between the signal converting interface card and the storage module, and for transmitting a processed signal that is outputted by the signal converting interface card as a result of processing the first test signal to the storage module. The third specification bus has one end that is adapted for coupling to an output end of the second specification interface controller and another end that is adapted for coupling to an input end of the second specification interface controller such that the third specification bus forms a closed or loopback circuit with the second specification interface controller. The one end of the third specification bus receives a second test signal that is outputted by the second specification interface controller, and the another end of the third specification bus transmits the second test signal back to the second specification interface controller.

Preferably, the first specification interface controller is one of a Peripheral Component Interconnect Express (PCI-E) controller and a Serial ATA (SATA) controller, the second specification interface controller is the other one of the PCI-E controller and the SATA controller, the first specification bus is one of a PCI-E bus and a SATA bus, and the third specification bus is the other one of the PCI-E bus and the SATA bus.

Moreover, the test interface card of the present invention can be integrated with the signal converting interface card so as to comprise a signal converting module, a first specification bus, a second specification bus and a third specification bus.

The signal converting module is for performing specification conversion on signals received thereby. The first specification bus is coupled to the signal converting module and is adapted for coupling to the first specification interface controller, and for transmitting a first test signal outputted by the first specification interface controller to the signal converting module. The second specification bus is coupled to the signal converting module and is adapted for coupling to the storage module, and for transmitting a processed signal outputted by the signal converting module to the storage module, the processed signal resulting from processing of the first test signal. The third specification bus has one end adapted for coupling to an output end of the second specification interface controller and another end adapted for coupling to an input end of the second specification interface controller such that the third specification bus forms a closed or loopback circuit with the second specification interface controller. The one end of the third specification bus receives a second test signal outputted by the second specification interface controller, and the another end of the third specification bus transmits the second test signal back to the second specification interface controller.

Another object of the present invention is to provide a testing method adapted for testing a device under test (DUT) against different specification buses.

According to the present invention, there is provided a testing method adapted for testing a DUT. The DUT has a first specification interface controller, a second specification interface controller, a storage module, a first specification bus, a second specification bus and a third specification bus. The testing method comprises the steps of:

(A) coupling the first specification bus between the first specification interface controller and a signal converting interface card, coupling the second specification bus between the signal converting interface card and the storage module, and coupling one end of the third specification bus to an output end of the second specification interface controller and coupling another end of the third specification bus to an input end of the second specification interface controller such that the third specification bus forms a closed or loopback circuit with the second specification interface controller;

(B) configuring the first specification interface controller to transmit a first test signal to the signal converting interface card through the first specification bus so that the signal converting interface card, in response, transmits a processed signal to the storage module through the second specification bus, the processed signal resulting from performing specification conversion on the first test signal; and

(C) configuring the second specification interface controller to transmit a second test signal through the one end of the third specification bus so that the second test signal passes through the third specification bus and is transmitted back to the second specification interface controller via the another end of the third specification bus.

The advantage of the present invention resides in providing a test interface card that enables testing of the DUT against many different specification buses and conserves testing resources.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic circuit block diagram illustrating a conventional test circuit for testing a DUT against a PCI-E bus and a SAS bus;

FIG. 2 is a schematic circuit block diagram illustrating a conventional test circuit for testing the DUT against a SATA bus and the SAS bus;

FIG. 3 is a schematic circuit block diagram illustrating a first preferred embodiment of a test interface card according to the present invention;

FIG. 4 is a flowchart for illustrating testing of a DUT using the first preferred embodiment of a test interface card;

FIG. 5 is a schematic circuit block diagram for illustrating a transmission route of a test signal through a loopback circuit formed by a third specification bus of the preferred embodiment with a SATA controller of the DUT;

FIG. 6 is a schematic circuit block diagram illustrating a second preferred embodiment of a test interface card according to the present invention;

FIG. 7 is a schematic circuit block diagram illustrating a third preferred embodiment of a test interface card according to the present invention;

FIG. 8 is a flowchart for illustrating testing of a DUT using the third preferred embodiment of a test interface card; and

FIG. 9 is a schematic circuit block diagram illustrating a fourth preferred embodiment of a test interface card according to the present invention.

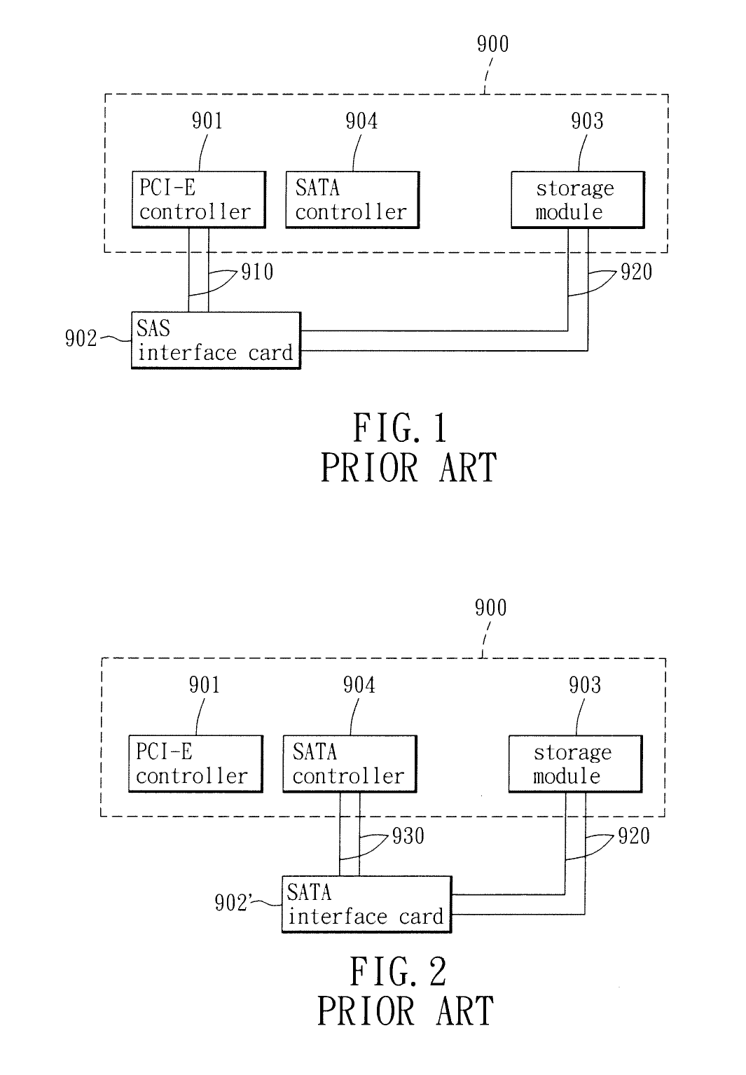

### DETAILED DESCRIPTION OF THE PREFERRED EMBODIMENTS

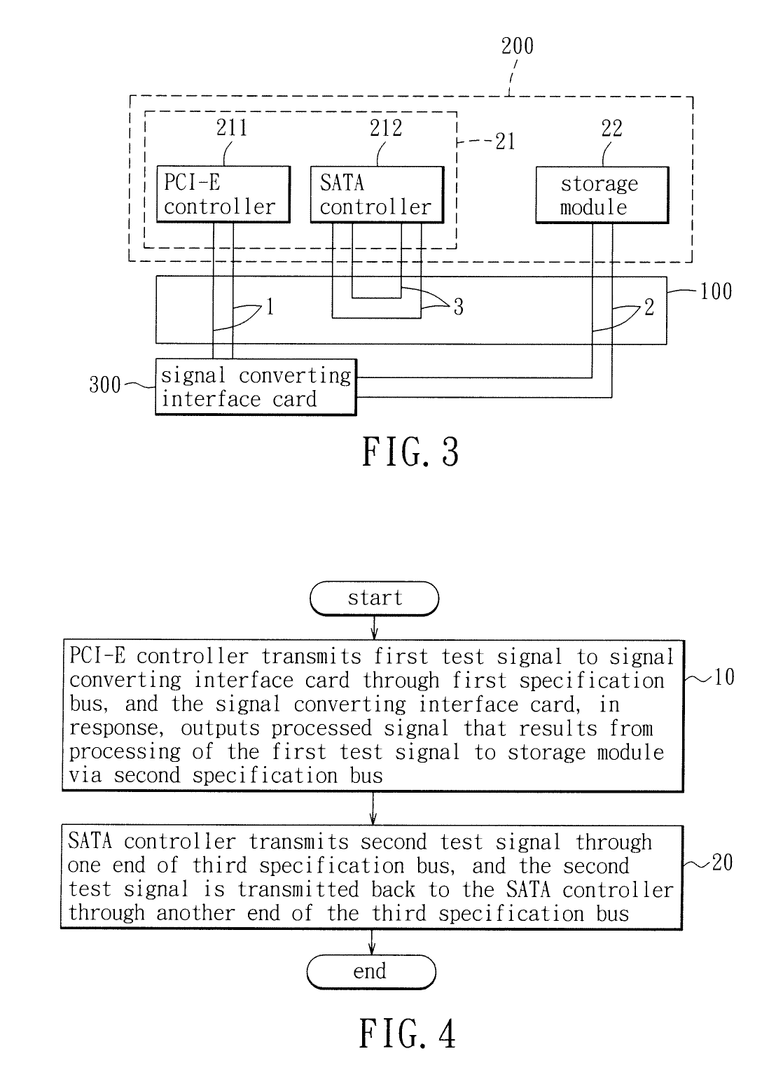

FIG. 3 illustrates a first preferred embodiment of a test interface card 100 according to the present invention. The test interface card 100 is adapted to be coupled between a device under test (DUT) 200 and a signal converting interface card 300. A wiring design of buses in the test interface card 100 allows the formation of test circuits with the DUT 200 that enable testing of the DUT 200 against many different specification buses without requisite exchange of the signal converting interface card 300, thus reducing testing time and costs.

In this embodiment, the DUT 200 is a blade server including a testing module 21 and a storage module 22, but is not limited to such. The testing module 21 is an I/O Controller Hub 9 (ICH9) chip having a first specification interface controller 211 and a second specification interface controller 212. The first specification interface controller 211 is a Peripheral Component Interconnect Express (PCI-E) controller 211, and the second specification interface controller 212 is a Serial Advanced Technology Attachment (SATA) controller 212, though the types of the specification interface controllers 211,212 are not limited to such. The storage module 22 is an HDD backplane for receiving a signal outputted from the signal converting interface card 300, and for transmitting an acknowledgement signal to the testing module 21 upon receipt of the signal.

In this embodiment, the test interface card 100 comprises a first specification bus 1, a second specification bus 2 and a third specification bus 3.

The first specification bus 1 is coupled between the PCI-E controller 211 of the testing module 21 and the signal converting interface card 300 for transmitting a first test signal outputted by the PCI-E controller 211 to the signal converting interface card 300 for processing. In this embodiment, the first specification bus 1 is a PCI-E bus, and the first test signal is a PCI-E test signal.

The second specification bus 2 is coupled between the signal converting interface card 300 and the storage module 22 for transmitting a processed signal that is outputted by the signal converting interface card 300 as a result of processing the first test signal to the storage module 22. Since a SAS controller for outputting a SAS test signal is not included in the testing module 21 of this embodiment, the signal converting interface card 300 of this embodiment is a Serial Attached SCSI (SAS) interface card used for converting a specification of the PCI-E test signal (the first test signal) to the SAS specification, and for transmitting a SAS test signal (the processed signal) to the storage module 22 via the second specification bus 2. In this embodiment, the second specification bus 2 is correspondingly a SAS bus.

The third specification bus 3 has one end that is coupled to an output end of the SATA controller 212 of the testing module 21 and another end that is coupled to an input end of the SATA controller 212 such that the third specification bus 3 forms a closed or loopback circuit with the SATA controller 212. The one end of the third specification bus 3 receives a second test signal that is outputted by the SATA controller 212, and the another end of the third specification bus 3 transmits the second test signal back to the SATA controller 212. In this embodiment, the third specification bus 3 is a SATA bus, and the second test signal is a SATA test signal.

FIG. 4 illustrates testing of the DUT 200 using the test interface card 100 of this embodiment. It should be noted that the DUT 200 is presumed to have entered a test mode for performing the following steps.

In step 10, the PCI-E controller 211 of the testing module 21 transmits the first test signal (the PCI-E test signal) to the signal converting interface card 300 through the first specification bus 1, and the signal converting interface card 300, in response, transmits the processed signal (the SAS test signal) to the storage module 22 via the second specification bus 2. As previously mentioned, the processed signal results from performing specification conversion on the first test signal, i.e., converting the PCI-E test signal to the SAS test signal. Since in this embodiment it is necessary to determine whether the test signals are accurately transmitted through respective ones of the buses 1,2, when the storage module 22 receives the SAS test signal indicating that the DUT 200 has passed testing against the first specification bus 1 and the second specification bus 2, the storage module 22 transmits an acknowledgement signal to the testing module 21 so as to inform the testing module 21 of a satisfactory test result.

In step 20, the SATA controller 212 of the testing module 21 transmits the second test signal (the SATA test signal) through the one end of the third specification bus 3 so that the second test signal passes through the third specification bus 3 and is transmitted back to the SATA controller 212 via the another end of the third specification bus 3.

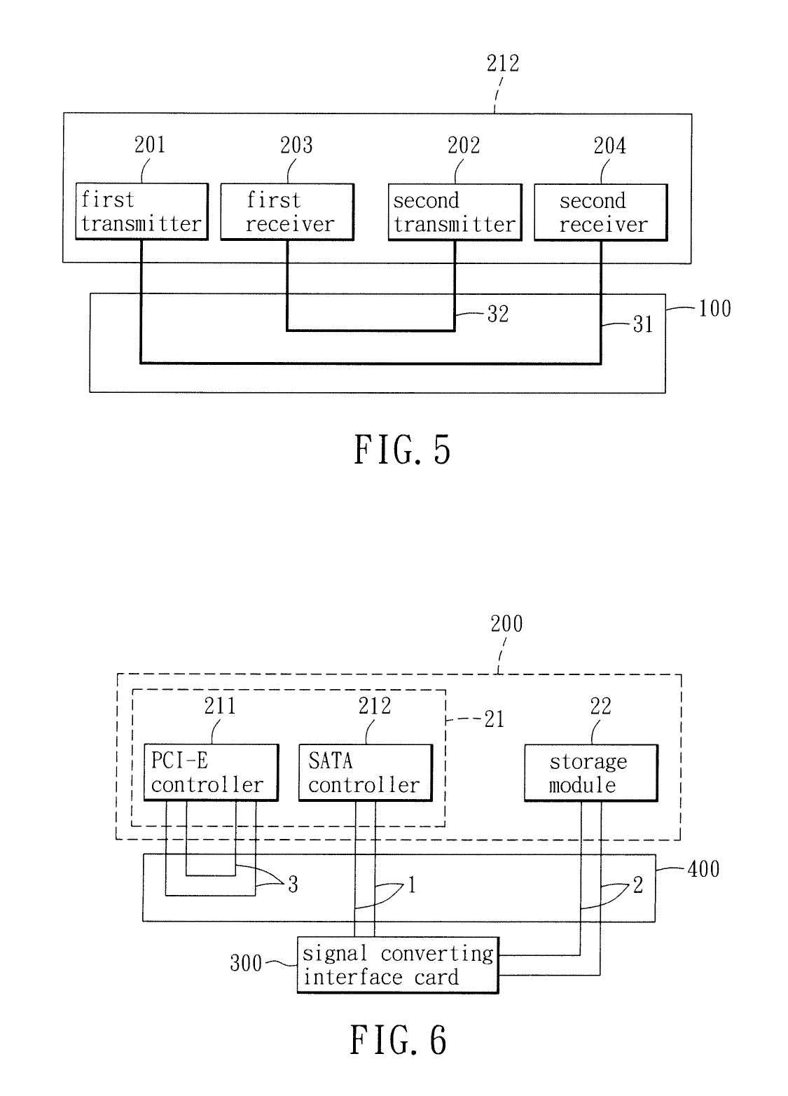

FIG. 5 illustrates a transmission route of the second test signal in detail. The SATA controller 212 has a first transmitter 201, a second transmitter 202, a first receiver 203 and a second receiver 204, and the third specification bus 3 has a first cable 31 and a second cable 32, the first cable 31 being coupled between the first transmitter 201 and the second receiver 204, and the second cable 32 being coupled between the second transmitter 202 and the first receiver 203. In step 20, the SATA controller 212 transmits the second test signal from the first transmitter 201 to the second receiver 204 via the first cable 31, then transmits the second test signal from the second transmitter 202 to the first receiver 203 via the second cable 32 so as to complete testing of the DUT 200 against the third specification bus 3.

It has thus been shown that the test interface card 100 of this embodiment, after being coupled to the DUT 200 and the signal converting interface card 300, facilitates testing of the DUT 200 as described in steps 10 and 20 through eliminating the need to exchange the signal converting interface card 300 for one corresponding to the specification bus against which the DUT 200 is to be tested, and thus reduces testing time and costs.

FIG. 6 illustrates a second preferred embodiment of the test interface card 400 according to the present invention that differs from the first preferred embodiment in that the first specification bus 1 of the test interface card 400 is coupled between the SATA controller 212 of the testing module 21 and the signal converting interface card 300, and the third specification bus 3 is coupled to the PCI-E controller 211 such that the third specification bus 3 forms a loopback circuit with the PCI-E controller 211. It is worth noting that in this embodiment, the signal converting interface card 300 is a SATA interface card capable of converting the SATA test signal (a first test signal) to a SAS test signal (a processed signal), and transmitting the SAS test signal to the storage module 22.

The test interface card 400 of this embodiment, like that of the first preferred embodiment, facilitates testing of the DUT 200 through eliminating the need to exchange the signal converting interface card 300 for one corresponding to the specification bus against which the DUT 200 is to be tested, and thus reduces testing time and costs.

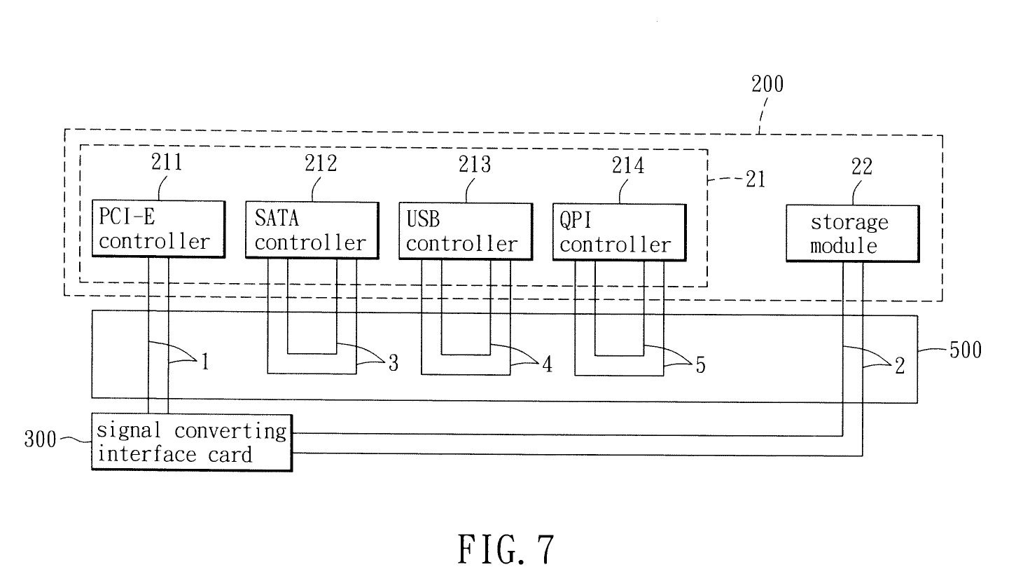

FIG. 7 illustrates a third preferred embodiment of a test interface card 500 according to the present invention that differs from the first preferred embodiment in that the test interface card 500 has a fourth specification bus (Universal Serial Bus (USB)) 4 and a fifth specification bus (Quick Path Interconnect (QPI)) 5. It should be noted that the quantity of the specification buses is not limited to what is described herein.

In this embodiment, the testing module 21 further includes a USB controller 213 corresponding to the fourth specification bus 4 and a QPI controller 214 corresponding to the fifth specification bus 5.

The manner in which the fourth specification bus 4 is coupled to the USB controller 213 is the same as the manner in which the third specification bus 3 is coupled to the SATA controller 212: one end of the fourth specification bus 4 is coupled to the output end of the USB controller 213, and another end is coupled to the input end of the USB controller 213 such that the fourth specification bus 4 forms a loopback circuit with the USB controller 213. The one end of the fourth specification bus 4 receives a third test signal outputted by the USB controller 213, and the another end of the fourth specification bus 4 transmits the third test signal back to the USB controller 213. The third test signal is a USB test signal.

The manner in which the fifth specification bus 5 is coupled to the QPI controller 214 is also the same as the manner in which the third specification bus 3 is coupled to the SATA controller 212: one end of the fifth specification bus 5 is coupled to an output end of the QPI controller 214, and another end is coupled to an input end of the QPI controller 214 such that the fifth specification bus 5 forms a loopback circuit with the QPI controller 214. The one end of the fifth specification bus 5 receives a fourth test signal outputted by the QPI controller 214, and the another end of the fifth specification bus 5 transmits the fourth test signal back to the QPI controller 214. The fourth test signal is a QPI test signal.

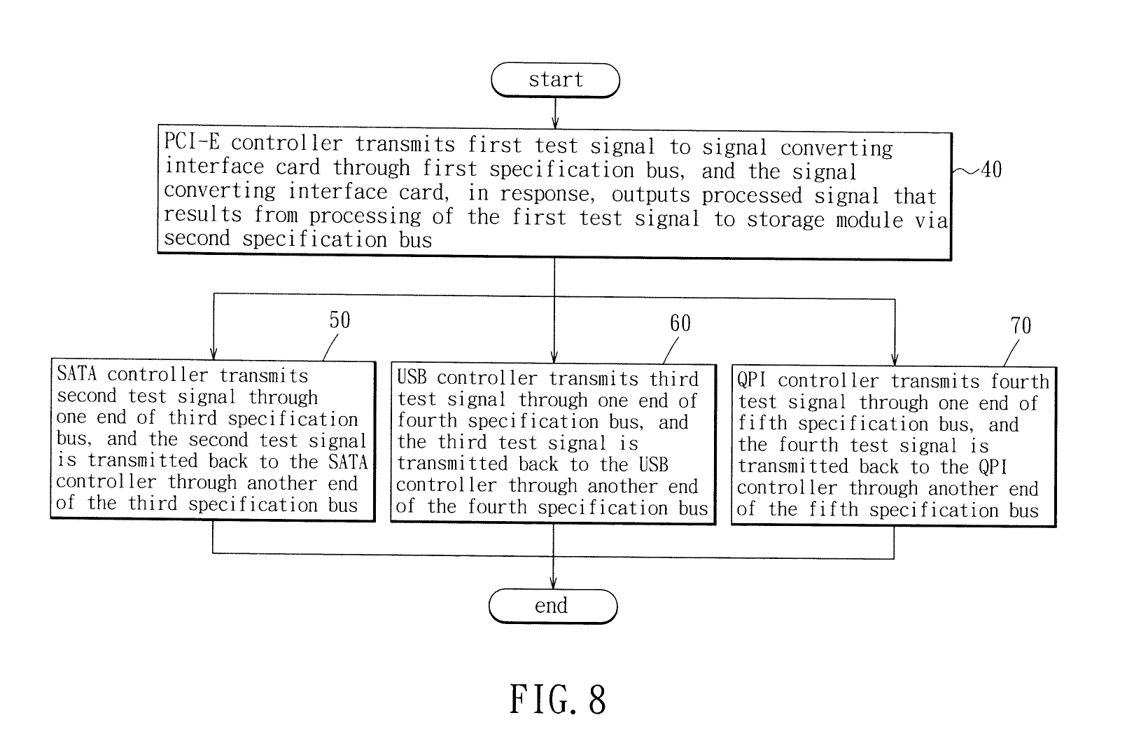

FIG. 8 illustrates a method for testing the DUT 200 using the test interface card 500 of this embodiment. It is again presumed that the DUT 200 has entered a test mode for performing the following steps.

In step 40, the PCI-E controller 211 of the testing module 21 outputs the first test signal to the signal converting interface card 300 through the first specification bus 1, and the signal converting interface card 300, in response, transmits the processed signal to the storage module 22 through the second specification bus 2, the processed signal resulting from performing specification conversion on the first test signal. Since this step is the same as step 10 of the first preferred embodiment, details thereof are omitted for the sake of brevity.

After completion of step 40, the testing module 21 can simultaneously perform steps 50,60 and 70, on account of each of the specification buses 3,4,5 being coupled to a corresponding one of the specification interface controllers 212,213,214 such that each of the specification buses 3,4,5 forms a loopback circuit with the corresponding one of the specification interface controllers 212,213,214.

In step 50, the SATA controller 212 of the testing module 21 transmits the second test signal through the one end of the third specification bus 3 so that the second test signal passes through the third specification bus 3 and is transmitted back to the SATA controller 212 via the another end of the third specification bus 3.

In step 60, the USB controller 213 of the testing module 21 transmits the third test signal through the one end of the fourth specification bus 4, so that the third test signal passes through the fourth specification bus 4 and is transmitted back to the USB controller 213 via the another end of the fourth specification bus 4.

In step 70, the QPI controller 214 of the testing module 21 transmits a fourth test signal through the one end of the fifth specification bus 5 so that the fourth test signal passes through the fifth specification bus 5 and is transmitted back to the QPI controller 214 via the another end of the fifth specification bus 5. This embodiment of the test interface card 500 reduces testing time and costs not only through elimination of the need to exchange the signal converting interface card 300 during testing, but also through allowing simultaneous testing of the DUT 200 against the third, fourth and fifth specification buses 3,4,5. Such simultaneous testing is enabled through the loopback circuits formed by the specification buses 3,4,5 with the specification interface controllers 212,213,214.

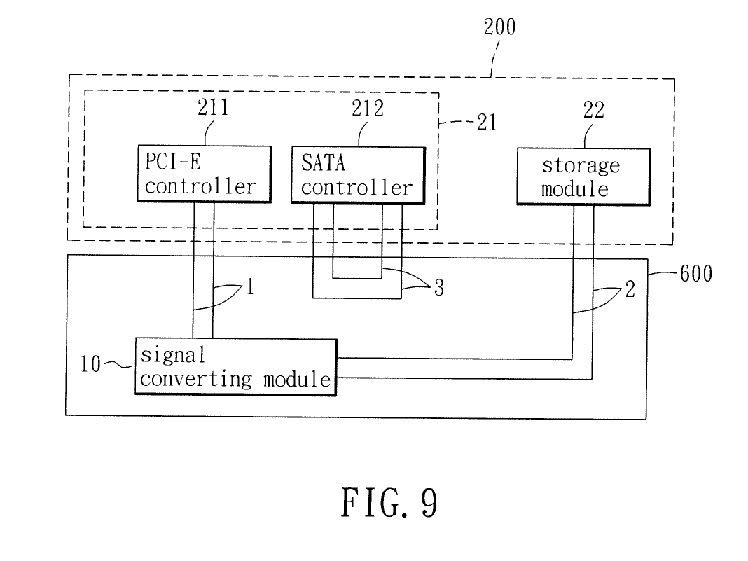

FIG. 9 illustrates a fourth preferred embodiment of the test interface card 600 according to the present invention that differs from the first preferred embodiment in that the test interface card 600 includes a signal converting module 10 used for performing specification conversion on signals received thereby and subsequently outputting a processed signal. It should be noted that the function of the signal converting module 10 is the same as that of the signal converting interface card 300 (see FIG. 3) described in the first preferred embodiment. Therefore, the test interface card 600 of this embodiment is essentially that which integrates in a single interface card the test interface card 100 and the signal converting interface card 300 described in the first preferred embodiment.

In this embodiment, the first specification bus 1 is coupled between the PCI-E controller 211 of the testing module 21 and the signal converting module 10, and the second specification bus 2 is coupled between the signal converting module 10 and the storage module 22. The signal converting module 10, after performing specification conversion on the first test signal (i.e., converting the PCI-E test signal to a SAS test signal), transmits the processed signal to the storage module 22. The test interface card 600 of this embodiment, like those of the previous embodiments, facilitates testing of the DUT 200 through eliminating the need to replace a signal converting interface card 300 during testing of the DUT 200 against different specification buses, and thus reduces testing time and costs.

In summary, the test interface card 100,400,500,600 of the present invention, in which one bus thereof is coupled between the testing module 21 and the signal converting interface card 300 (or signal converting module 10), another bus thereof is coupled between the signal converting interface card 300 (or signal converting module 10) and the storage module 22, and each remaining bus thereof is coupled to a corresponding controller such that the bus forms a loopback circuit with the corresponding controller, eliminates the need to exchange the signal converting interface card 300 during testing, thus facilitating testing of the DUT 200 and reducing testing time and costs.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A test interface card adapted to be coupled between a device under test (DUT) and a signal converting interface card for facilitating testing of the DUT, the DUT having a first specification interface controller, a second specification interface controller and a storage module, said test interface card comprising:
a first specification bus adapted for coupling between the first specification interface controller and the signal converting interface card, and for transmitting a first test signal that is outputted by the first specification interface controller to the signal converting interface card for processing;
a second specification bus adapted for coupling between the signal converting interface card and the storage module, and for transmitting a processed signal that is outputted by the signal converting interface card as a result of processing the first test signal to the storage module; and
a third specification bus, one end of which is adapted for coupling to an output end of the second specification interface controller and another end of which is adapted for coupling to an input end of the second specification interface controller such that said third specification bus forms a closed circuit with the second specification interface controller, said one end of said third specification bus receiving a second test signal that is outputted by the second specification interface controller, said another end of said third specification bus transmitting the second test signal back to the second specification interface controller.

2. The test interface card as claimed in claim 1, the signal converting interface card being a Serial Attached SCSI card (SAS card), wherein said second specification bus is a SAS bus through which the signal converting interface card outputs the processed signal to the storage module, the processed signal resulting from converting a specification of the first test signal to a SAS specification.

3. The test interface card as claimed in claim 2, the first specification interface controller being one of a Peripheral Component Interconnect Express (PCI-E) controller and a Serial ATA (SATA) controller, the second specification interface controller being the other one of the PCI-E controller and the SATA controller, wherein said first specification bus is one of a PCI-E bus and a SATA bus, and said third specification bus is the other one of the PCI-E bus and the SATA bus.

4. A testing method adapted for testing a device under test (DUT), the CUT having a first specification interface controller, a second specification interface controller, a storage module, a first specification bus, a second specification bus and a third specification bus, said testing method comprising the steps of:
(A) coupling the first specification bus between the first specification interface controller and a signal converting interface card, coupling the second specification bus between the signal converting interface card and the storage module, and coupling one end of the third specification bus to an output end of the second specification interface controller and coupling another end of the third specification bus to an input end of the second specification interface controller such that the third specification bus forms a closed circuit with the second specification interface controller;
(B) configuring the first specification interface controller to transmit a first test signal to the signal converting interface card through the first specification bus so that the signal converting interface card, in response, transmits a processed signal to the storage module through the second specification bus, the processed signal resulting from performing specification conversion on the first test signal; and
(C) configuring the second specification interface controller to transmit a second test signal through said one end of the third specification bus so that the second test signal passes through the third specification bus and is transmitted back to the second specification interface controller via said another end of the third specification bus.

5. The testing method as claimed in claim 4, the signal converting interface card being a Serial Attached SCSI card (SAS card), the second specification bus being a SAS bus, wherein the signal converting interface card transmits the processed signal to the storage module, the processed signal resulting from converting a specification of the first test signal to a SAS specification.

6. The testing method as claimed in claim 5, the first specification interface controller being one of a Peripheral Component Interconnect Express (PCI-E) controller and a Serial ATA (SATA) controller, the second specification interface controller being the other one of the PCI-E controller and the SATA controller, the first specification bus being one of a PCI-E bus and a SATA bus, and the third specification bus being the other one of the PCI-E bus and the SATA bus.

7. A test interface card adapted to be coupled to a device under test (DUT) for facilitating testing of the DUT, the DUT having a first specification interface controller, a second specification interface controller and a storage module, said test interface card comprising:
a signal converting module for performing specification conversion on signals received thereby;
a first specification bus coupled to said signal converting module and adapted for coupling to the first specification interface controller, and for transmitting a first test signal outputted by the first specification interface controller to said signal converting module;
a second specification bus coupled to said signal converting module and adapted for coupling to the storage module, and for transmitting a processed signal outputted by said signal converting module to the storage module, the processed signal resulting from processing of the first test signal; and
a third specification bus having one end adapted for coupling to an output end of the second specification interface controller and another end adapted for coupling to an input end of the second specification interface controller such that said third specification bus forms a closed circuit with the second specification interface controller, said one end of said third specification bus receiving a second test signal outputted by the second specification interface controller, said another end of said third specification bus transmitting the second test signal back to the second specification interface controller.

8. The test interface card as claimed in claim 7, wherein said second specification bus is a Serial Attached SCSI (SAS) bus, and said signal converting module transmits the processed signal resulting from converting a specification of the first test signal to a SAS specification to the storage module.

9. The test interface card as claimed in claim 8, the first specification interface controller being one of a Peripheral Component Interconnect Express (PCI-E) controller and a Seri al ATA (SATA) controller, the second specification interface controller being the other one of a PCI-E controller and a SATA controller, wherein said first specification bus is one of a PCI-E bus and a SATA bus, and said third specification bus is the other one of a PCI-E bus and a SATA bus.
